(19) United States
(12) Patent Application Publication
(10) Pub. No.: US 2019/0302344 A1
(43) Pub. Date: Oct. 3, 2019

(54) A LIGHTING SYSTEM USING A LIGHT GUIDING STRUCTURE

(71) Applicant: PHILIPS LIGHTING HOLDING B.V., EINDHOVEN (NL)

(72) Inventors: SILVIA MARIA BOOIJ, EINDHOVEN (NL); JOHANNES MARIA THIJSSEN, BEST (NL)

(21) Appl. No.: 16/305,948

(22) PCT Filed: Jun. 7, 2017
(86) PCT No.: PCT/EP2017/063754

§ 371 Date: Nov. 30, 2018

(30) Foreign Application Priority Data
Jun. 16, 2016 (EP) 16174806.6

(51) Int. Cl. F21V 8/00

(52) U.S. Cl. CPC G02B 6/0048; G02B 6/003; G02B 6/0063

(57) ABSTRACT

A lighting system comprises an elongate light guiding structure comprising a input edge miming along the length of the structure, and first and second side walls which extend between the input edge and a end face, at least one of which is stepped. The steps comprise at least a first step region which forms a total internal reflection surface for the light provided into the light guiding structure from the input edge such that light leaves the light guiding structure from the second side wall, and at least a second step region which forms a refracting interface for the light provided into the light guiding structure from the input edge such that light leaves the light guiding structure from the first side wall. In this way the use of refraction and total internal reflection is combined to enable flexibility in the control of the light output distribution as well as the appearance of the system. The lighting system for example comprises luminaire for ceiling mounting.

### FIELD OF THE INVENTION

This invention relates to lighting systems, and in particular lighting systems which use a light guiding structure to shape and direct the light output from a light source, such as an LED arrangement.

### BACKGROUND OF THE INVENTION

A luminaire generally comprises a light source (and associated driver) and an optical output structure for shaping and directing the output light. There are many different possible designs for the optical output structure, such as a lens plate, a diffuser plate, a scattering structure, or a light mixing box.

Luminaires can sometimes be perceived as uncomfortable and glary, especially LED luminaires. This is caused by two factors. First, the small size of the light emitting sources means they are very bright when looking directly into them. Second, because the light sources are so small, the light from them can be directed very precisely, but this can cause undesirably steep gradients in the output light distribution.

Avoiding these steep gradients is a matter of proper design. Avoiding observers being able to look back into the light source directly can also be solved in a number of ways. One way to reduce the perceived brightness is by creating a larger virtual source using an optical lens and/or diffuser design. This solution can be found in many existing products like TV backlights, luminaires etc. However, by making a virtually larger source, the efficiency and/or the control over the light output distribution is often compromised.

It is known to use light guiding structures (light guides) as part of the optical output structure. A light guiding structure propagates light using total internal reflection, and the light escapes at locations where this total internal reflection is interrupted, for example by light outcoupling structures.

Light guides are traditionally used to uniformly illuminate a surface, and in particular when there is very limited height, for example as is the case for a display backlight. Usually, the control of the direction of the light is not very important. In the case of a display backlight, the outcoupling is achieved either with paint dots, diffractive structures or total internal reflection structures. Beam shaping from this type of device is generally not required. If steering of the light is possible, more light in a direction perpendicular to the plane of the device is preferred, in order to obtain a brighter view when looking straight at the device.

More recently, light guides are being used within more general lighting elements, such as candle bulbs and automotive daytime running lights. Usually the light distribution from the light source is not very strict, whereas the outer appearance is of particular importance. Outcoupling of the light is preferably achieved using total internal reflection as this maintains a high efficiency.

There is generally a compromise between the appearance of a luminaire and the ability to control the light output. In terms of appearance, for general illumination lighting, it is generally desirable to be able to see a luminaire from a distance (for example to provide a guiding function), and often some upwardly directed light (“up-light”) is desirable, which is light which illuminates the ceiling above or next to the luminaire.

These objectives are difficult to achieve in practice. For example, when using total internal reflection, a light output direction close (e.g. within 25 degrees) to the lighting input direction from the light source is difficult to control using total internal reflection, whereas total internal reflection is desired for efficiency reasons as mentioned above. If the critical angle for total internal reflection is close to the light input direction, this results in a large spread of the beam and some light undesirably coupled out or not coupled out at all.

### SUMMARY OF THE INVENTION

The invention is defined by the claims.

According to examples in accordance with an aspect of the invention, there is provided a lighting system, comprising:

an elongate light guiding structure comprising a input edge running along the length of the structure, and first and second opposite side walls which extend between the input edge and a end face, wherein at least one of the side walls has a stepped surface;

a light source arrangement provided at the input edge for providing light into the input edge and directed towards the end face,

wherein the steps of the stepped side wall define a narrowing of the width of the light guiding structure, and wherein the steps comprise at least a first step region which forms a total internal reflection surface for the light provided into the light guiding structure from the input edge such that light leaves the light guiding structure from the opposite side wall, and at least a second step region which forms a refracting interface for the light provided into the light guiding structure from the input edge such that light leaves the light guiding structure from the same side wall, wherein at least one of said at least one stepped side wall comprises both first and second step regions.

When mounted in a vertical orientation, the input edge may be referred to as top edge, the end face may be referred to as bottom edge and reversed light may be referred to as uplight. Typically for mounting in vertical position the elongate light guiding structure at, adjacent or near to the input edge (or top edge) then is provided with mounting means, for example indentations or protrusions for matching with a clamp, a threaded hole for a bolt, or an affixed magnet for mounting on metal ceiling parts.

This system has a generally slab shaped light guiding structure. Light is introduced along an edge, i.e. a narrow strip, which extends along the length and has a width. The light is in a direction normal to the edge, and may be considered to extend in a depth direction. At least one side wall is stepped to form a narrowing of the width. The steps (on one or both side walls), also referred to as facets, define both refractive light steering surfaces and total internal reflection light steering surfaces. They form narrowing regions. By making use of both refraction without total internal reflection and total internal reflection, there is a significant flexibility in controlling the light output direction and thus intensity distribution. Furthermore, one or both side walls are designed to be visible in use, and they can be designed taking into account aesthetic considerations. In this way, the light distribution and the appearance of the device are both controlled. The light output efficiency is high and the system can be controllably manufactured.

The system achieves a desired light distribution in the far field, and also provides a desired appearance of the luminaire by making the light exit from lines on the light guiding structure (the steps and/or locations opposite the steps) which aim the light in a desired direction.

The total internal reflection may be used for controlling the output light over a first range of angles, and the refraction may be used for controlling the output light over a second range of angles. For example, refraction may be used to couple out light in directions at least between 0 and 25 degrees with respect to the light input direction to the light guiding structure, and in this way, the light distribution can be controlled accurately. This is combined with total internal reflection for out-coupling light in directions above a certain angle such as 25 degrees.

These two ranges may be distinct but they may instead overlap. For example, they may overlap in a range such as 25 to 50 degrees and this may be used to smoothen out optical artifacts. In such a case, the refraction is then used to couple out light in directions between 0 and 50 degrees, and total internal reflection may be used between 25 and 90 degrees.

The first and second step regions may be adjacent such that they define a single narrowing region. In this way, a single step has both a refractive interface and a total internal reflection surface. The total internal reflection surface for example redirects light to the other side from where it may be output.

Alternatively, the first and second step regions may be spaced by a planar (flat or gently curved) region, such that they define separate narrowing regions.

Both the first and second side walls may be stepped. The overall system may be side-to-side symmetric and provide a symmetric intensity distribution. Each side wall may have refraction steps and total internal reflection steps, or else the refraction steps may be on one side and the reflection steps on the other side.

A step of the first side wall and a step of the second side wall may be adapted together to create an reversed light path having a direction component from the end face to the input edge. By using two redirections (total internal reflection then refraction) it becomes possible to implement a redirection of more than 90 degrees and provide a component of light which provides reversed lighting.

The steps are for example shaped along the elongate direction. This feature may be used to reduce the spottiness of discrete light sources and thereby provide a more uniform visual appearance of the lighting system.

The light source arrangement may comprise an array of point light sources, each having a collimator. By controlling the light input into the light guiding structure, the beam shaping and beam steering function of the light guiding structure is better controlled.

The elongated light guiding structure for example comprises a solid slab, wherein the collimators comprise a shaped part of the input edge of the slab. This provides a low cost solution. The collimators may instead be a discrete arrangement mounted to the slab. The point light sources for example comprise LEDs.

The end face may comprise a stepped region, for creating an reversed light path having a direction component from the end face to the input edge. Thus, an reversed light effect may be created either using the steps or by using the end face of the light guiding structure.

The principal light output from the system may be:

from only the first side wall; or

from only the second side wall; or

from both side walls.

Thus, different lighting effects may be implemented. In one set of examples, the light output defines a bat wing intensity profile with one wing from each side wall.

The system may comprise a second or further elongate light guiding structure, each light guiding structure defining one web of a multiple-web design. This design may be used to create combined lighting effects.

The system is for example adapted to be mounted such that the direction between the input edge and the end face is vertical. For a luminaire, a vertical mounting gives the luminaire a larger visible area (when viewed from a distance) compared to a horizontal luminaire.

### BRIEF DESCRIPTION OF THE DRAWINGS

Examples of the invention will now be described in detail with reference to the accompanying schematic drawings, in which:

FIG. 1 shows a slab-shaped luminaire in schematic form, mounted to a ceiling;

FIG. 2 shows a typical light intensity distribution from a horizontally mounted light guide luminaire;

FIG. 3 shows that a more preferred batwing distribution is achievable with a vertically mounted light guide luminaire;

FIG. 4 shows a refractive light path through a first design of light guide step;

FIG. 5 shows a refractive light path through a second design of light guide step;

FIG. 6 shows a total internal reflection light path through a third design of light guide step;

FIG. 7 shows how light leaves a light guide with respect to the main orientation of the light guide;

FIG. 8 shows how reversed light can be obtained by providing first and second total internal reflections;

FIG. 9 shows how reversed light can be obtained by providing total internal reflection and refractive redirection;

FIG. 10 shows a first example of a lighting system;

FIG. 11 shows a perspective view of the system of FIG. 10;

FIG. 12 shows an alternative to the design of FIG. 10, in which individual collimators are used;

FIG. 13 shows a polar light intensity distribution;

FIG. 14 shows how total internal reflection steps may be used to create reversed light;

FIG. 15 shows a modification based on a combined total internal reflection facet and refraction facet;

FIG. 16 shows a modification based on an undercut refraction facet and a total internal reflection facet;

FIG. 17 shows a symmetric design and shows that the end face of the light guide may also be provided with facets in order to provide reversed light;

FIG. 18 shows an asymmetric design;

FIG. 19 shows three possible curved facet designs;

FIG. 20 shows two light guides combined to form a U-shaped lighting system;

FIG. 21 shows two light guides combined to form a V-shaped lighting system, and

FIG. 22 shows a light guide issuing light from only one side wall via both refractive and TIR facets.

### DETAILED DESCRIPTION OF THE EMBODIMENTS

The invention provides a lighting system, comprising an elongate light guiding structure comprising a input edge running along the length of the structure, and first and second side walls which extend between the input edge and a end face, at least one of which is stepped. The steps comprise at least a first step region which forms a total internal reflection surface for the light provided into the light guiding structure from the input edge such that light (after total internal reflection) leaves the light guiding structure from the second side wall, and at least a second step region which forms a refracting interface for the light provided into the light guiding structure from the input edge such that light (directly) leaves the light guiding structure from the first side wall. In this way the use of refraction and total internal reflection is combined to enable flexibility in the control of the light output distribution as well as the appearance of the system. The lighting system for example comprises luminaire for ceiling mounting. The first and second step regions may be in either order starting from the input edge.

A first aspect of the design of the system, when used as a ceiling mounted luminaire, is that a vertical orientation may be used.

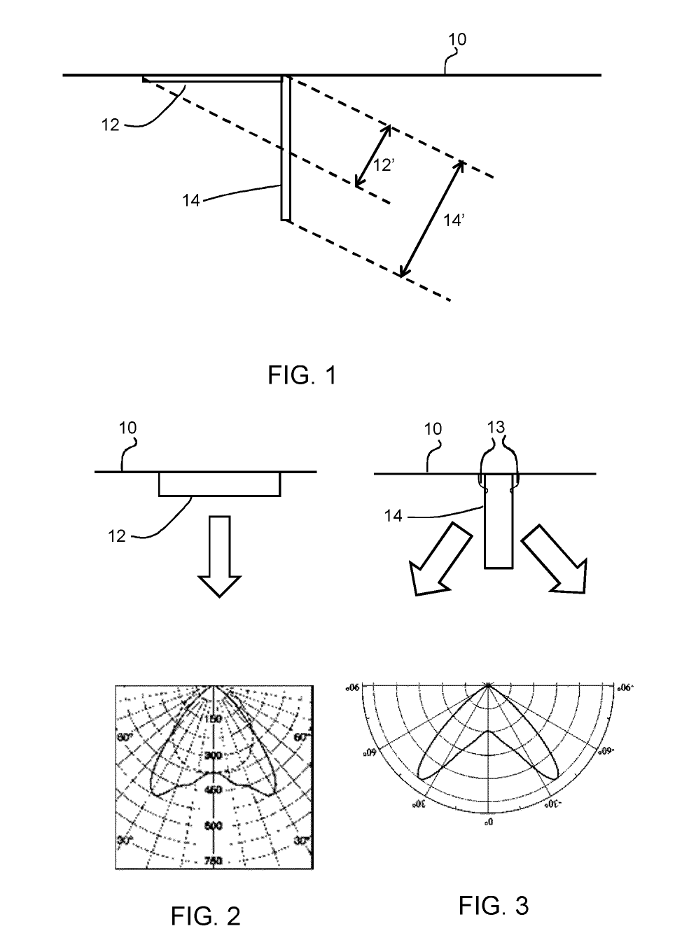

FIG. 1 shows a slab shaped luminaire in schematic form, mounted to a ceiling 10. The luminaire is shown horizontally mounted (flush with the ceiling) as reference 12, and vertically mounted (perpendicular to the ceiling) as 14. The perceived emitting surface area, as shown as 12′ and 14′ is larger from the far field for the vertical orientation. In an indoor space such as an office, there are more luminaires visible under these larger angles (i.e. from far away) than straight above the head, so that the appearance at these larger angles (large compared to the normal, vertical direction) is generally considered more important. The larger perceived emitting surface also results in lower glare for the same intensity distribution.

Luminaires which use light guides based on total internal reflection are generally placed in the horizontal plane if they are for example used in an office application where light is mainly needed perpendicular to the floor. However, a vertically oriented light guide is better suited for asymmetric or double asymmetric beams.

FIG. 2 shows a typical light intensity distribution from a horizontally mounted light guide luminaire 12 mounted to a ceiling 10.

FIG. 3 shows that a more preferred batwing distribution (that generates one or two peaks in the light distribution at angles between 30-80 degrees and less light around 0 degrees) is achievable with a vertically mounted light guide luminaire 14. The vertically mounted light guide luminaire thereto is attached to the ceiling 10 via a clamping structure 13 and thereto has indentations adjacent to the input/top edge.

The invention is based on the use of both refraction and total internal reflection from a light guiding structure, which will be termed a “light guide” below. The light guiding structure may however include other components such as an integrated collimator as well as a total internal reflection slab.

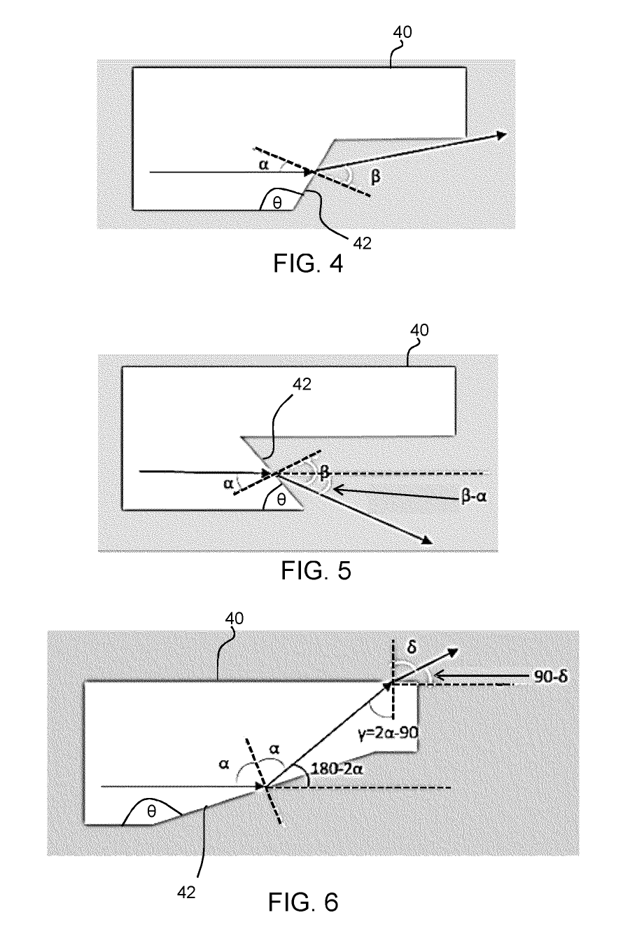

FIGS. 4 to 6 show some possible light paths through a light guide 40, which is a solid slab of material mounted in air, for example with a refractive index around 1.5, and more generally typically in the range 1.4 to 1.7 (e.g. glass or polycarbonate, PC, or poly methyl methacrylate, PMMA). The structure has a step 42 which performs a light steering function.

FIG. 4 shows a refractive light path which bends light inwardly (towards the slab). The step forms a narrowing of the width of the light guide 40, with an internal angle θ at the outer edge of the step which is more than 90 degrees. This provides a gradual transition to the narrower width with no acute external angle. At the step 42 the light is bent away from the normal, i.e. β>α. The light escapes from the light guide 40 at the step 42. The angle of the exit light with respect to the incident light may be controlled accurately, even if it is less than 25 degrees, based on the angle of the step 42 and the refractive index ratio.

FIG. 5 shows a refractive light path which bends light outwardly (away from the slab). The step forms a narrowing of the width of the light guide 40, with an internal angle θ at the outer edge of the step which is less than 90 degrees. This means the step forms an undercut with an acute external angle. At the step 42 the light is again bent away from the normal, i.e. β>α. The light escapes from the light guide at the step 42. The angle of the exit light with respect to the incident light can again be controlled accurately.

FIG. 6 shows a total internal reflection light path. The step forms a shallower narrowing of the width of the light guide 40, hence with an internal angle θ at the outer edge of the step which is closer to 180 degrees. At the step 42 the light undergoes total internal reflection because the incidence angle α relative to the normal is greater than the critical angle. The light escapes from the light guide at the opposite side, where there is a refractive boundary and the light is bent away from the normal at that (second) boundary.

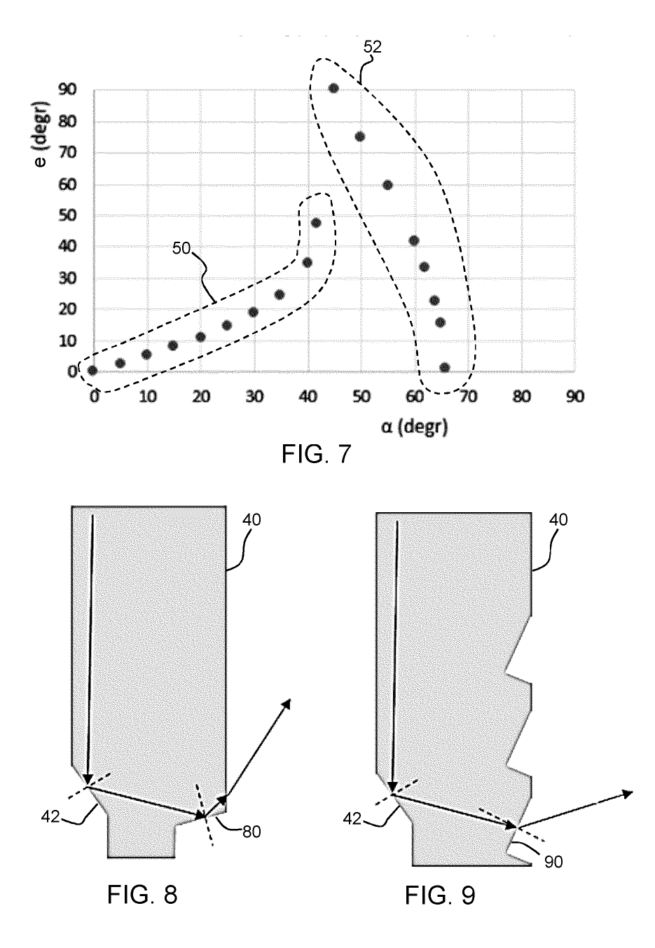

FIG. 7 shows how light leaves the light guide with respect to the main orientation of the light guide. On the horizontal axis is shown the angle of incidence α with respect to the step normal direction, for light traveling in the main direction of the light guide (left to right in the images of FIGS. 4 to 6). On the vertical axis is shown the exit angle e under which the light leaves the light guide again with respect to the light guide orientation.

This is based on a plane-parallel light guide with a smooth surface opposite the stepped surface as is shown in FIGS. 4 to 6.

The region 50 represents the refractive function and the region 52 represents the total internal reflection function.

Light that refracts in the light guide can easily leave the light guide in the direction of the light guide (i.e. with an exit direction e of 0 degrees) up to an exit angle e of around 50 degrees. Angles of incidence α (with respect to the step normal direction) up to the limiting angle of 41.8 degrees are possible, which corresponds to the critical angle for a refractive index n=1.5 in air, and larger angles are impossible due to total internal reflection.

Light that is reflected using total internal refraction can instead easily leave the light guide at 90 degrees (perpendicular to the light guide). Decreasing angles are possible for total internal reflection and in principle down to 0 degrees. However, the slope of the light exit angle with respect to the angle of incidence is much larger. This means that a small change in the angle of incidence to the step, or a small change in the slope of the step, results in a large change in exiting angle. Thus, control of the exit angle near 0 degrees is more controllable using refraction than total internal reflection. Furthermore, exit angles above 50 degrees can only be reached using total internal reflection.

For exit angles in the approximate range 25 to 50 degrees, total internal reflection and refraction can both be used, and they have a similar slope. Below 25 degrees the slope of the refraction curve 50 is much flatter which means that a small variation in the angle of incidence results in a small angle change in exit angle.

In practice, light inside a light guide is hardly ever perfectly collimated. Light is also hardly ever absolutely un-collimated, as this results in such a wide beam that accurately steering the beam becomes difficult. Some pre-collimation is thus desired.

By way of example, a typical collimated beam may have +/−5 degrees divergence inside the light guide. If the angle of incidence to a refractive facet is 10 degrees+/−5 degrees, the light will leave the light guide at angles in the range 5-10 degrees, which is even narrower than the initial beam. Thus, for small angles, a refractive facet does not result in beam spreading and is able provide accurate control of the output direction. If this same beam encounters a total internal reflection step of 55 degrees, the angles of incidence relative to this step will be 50-60 degrees, which results in exit angles of 75-40 degrees (from FIG. 7). The divergence of the beam has seriously increased because of the use of a total internal reflection step.

In order to obtain accurate control of the exit angles, the demands on the pre-collimation function in a system using total internal reflection is much higher than for refractive facets. In practice this will lead to unrealistic requirements of the pre-collimation when using total internal reflection facets for these angles.

If the nominal angle of incidence is too close to the upper limit of 65 degrees, then part of the beam will not leave the light guide at the opposite side anymore, and remain trapped in the light guide, or exit the light guide at another, unwanted, location.

FIGS. 4 to 6, discussed above, show how a step may be designed to provide a desired redirection of light in the generally forward direction. In some designs, in particular for indoor luminaires, it is also sometimes desirable to provide reversed light, namely light which is directed at least partly toward the ceiling. This means that the contrast between the luminaire and the surrounding ceiling becomes less sharp. Another factor is that the ceiling can then be seen so that the luminaire does not appear to be floating in a dark hole.

FIG. 8 shows how reversed light can be obtained by providing a first total internal reflection (as in FIG. 6) at a step 42 on one side of the light guide, then providing a second total internal reflection on a step 80 at the opposite side, followed by a refractive redirection when the light leaves the light guide 40.

FIG. 9 shows how reversed light can be obtained by providing a first total internal reflection (as in FIG. 6) at a step 42 on one side of the light guide, then providing a refractive redirection on a step 90 at the opposite side.

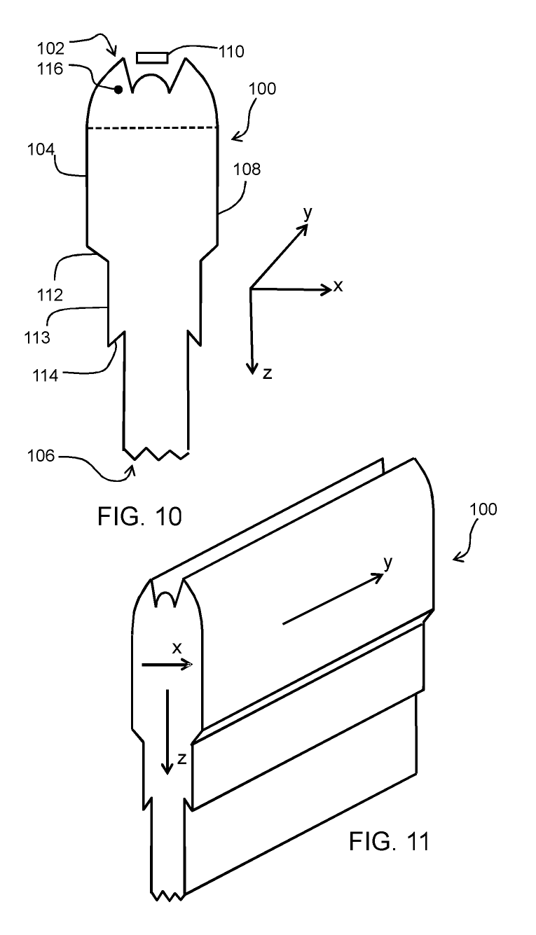

FIG. 10 shows a first example of a lighting system. It comprises an elongate light guide 100 formed as a slab of solid material with a refractive index greater than air (in which the slab is to be mounted) comprising a input edge 102 running along the length of the structure. FIG. 10 shows the structure in cross section perpendicular to the length direction. The light guide has a width which is defined as the x-axis direction, and the length direction (into the page for FIG. 10) is defined as the y-axis. The height as shown in FIG. 10 may be considered to be a depth direction and is defined as the z-axis.

The light guide 100 has a first, stepped, side wall 104 which extends between the input edge 102 and a end face 106 and a second side wall 108 opposite the first side wall 104. In the example shown, the second side wall 108 is also stepped but this is not essential as will be seen in examples below.

The steps each comprise a facet (or set of facets) which extends between planar (non-stepped) sections.

A light source arrangement 110 is provided at the input edge 102 for providing light into the input edge and directed towards the end face 106. Thus, light enters the light guide 100 in the depth (z-axis) direction from top to bottom.

The example shown has two steps. A first step 112 is a total internal reflection step of the type shown in FIG. 6. This means that light incident on the step 112 on the first side wall 104 leaves the light guide from the second side wall 108. Light incident on a total internal reflection step on the second side wall leaves light by the first side wall. A second step 114 is a refractive step of the type shown in FIG. 5. This means than that light incident on the step 114 leaves the light guide from the same (first) side wall 104.

Each step 112, 114 defines a narrowing of the width (x-axis) of the light guide. The steps may be in either order; the total internal reflection step does not need to be nearest the input edge. There may be many more steps, and any combination of total internal reflection steps and refraction steps is possible.

In this example, there are separate refractive and total internal reflection steps. There is a planar light guide section 113 between them. Instead a multi-faceted step may have a part that is refractive, and a part that uses total internal reflection.

FIG. 11 shows a perspective view of the system of FIG. 10 (omitting the LEDs 110). Light enters the light guide 100 from a limited number of sources. The input edge includes an in-coupling collimator 116. This ensures that the light is redirected in the forward direction (within a certain cone angle). The collimator may be formed as an integral part of the light guide.

The collimator can have a linear shape, beneath an array of LEDs, if collimation in one plane is mainly needed. This means the overall shape can be extruded as it can have a constant cross section along its length as can be seen in FIG. 11.

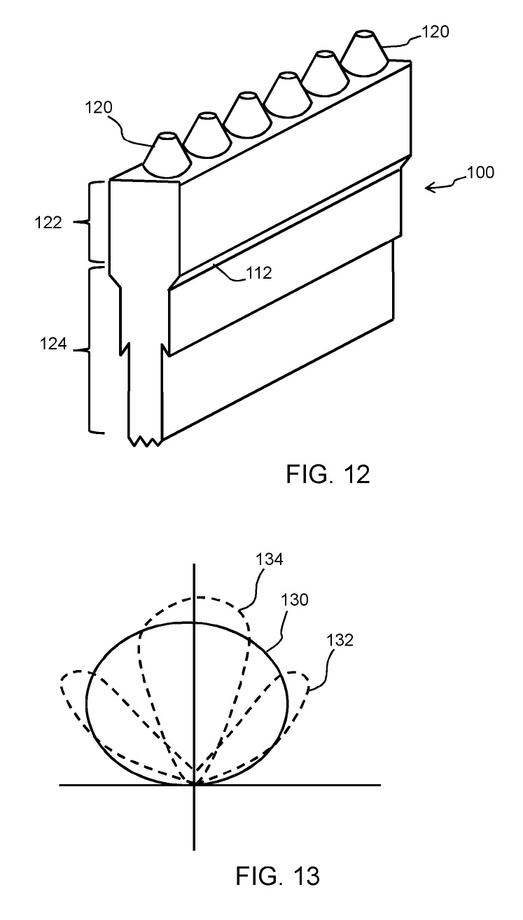

FIG. 12 shows an alternative in which individual collimators 120 are used each for one or more LEDs. The collimators 120 may then be rotationally symmetric for example, if collimation of the final beam is needed in all directions.

A further advantage of a linear collimator is that the same design can be used with different numbers of LEDs, whereas the use of individual collimators provides more control over the light distribution.

As illustrated in FIG. 12, the (partially) collimated light travels in a first part 122 of the light guide 100, which is used to mix the light, and create some distance between the LEDs and the first out-coupling step 112. This first part 122 of the light guide is not crucial for the light distribution, but a longer length of this part makes it easier to get uniform non-pixelated lines without losing control over the light distribution.

The next portion 124 of the light guide can be used to determine the appearance of the light guide. It consists of a sequence of steps that redirect the light in the guide. FIG. 12 shows only two steps (one of each type). However, there may be three or more steps with any desired combination of refracting and total internal reflection steps.

FIG. 13 shows the polar light intensity distribution. Plot 130 is the LED Lambertian distribution. Plot 132 is the contribution of the total internal reflection steps and plot 134 is the contribution of the refractive steps. The two contributions may be controlled independently.

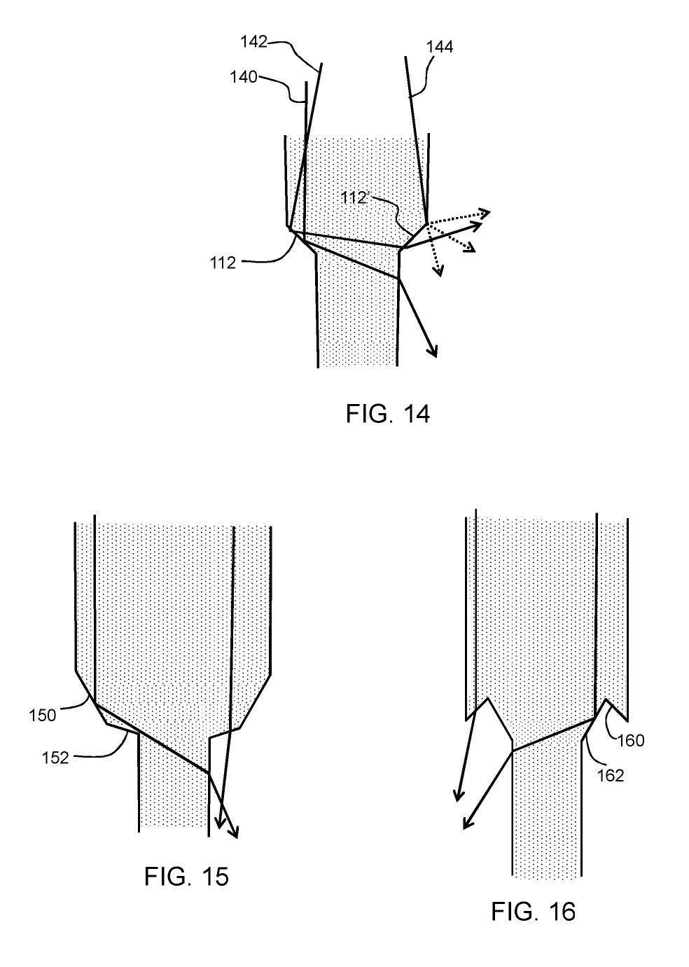

FIG. 14 shows how the total internal reflection steps 112 may be used to create reversed light as mentioned above. The beam 140 undergoes reflection and then refraction at a planar face to define a forward beam. The beam 142 undergoes one total internal reflection then refraction at an opposing total internal reflection step 112′. The incident angle to the second step 112′ is no longer in the depth direction so it no longer implements total internal reflection. As shown, the result is an upwardly directed component. Beam 144 is scattered at a corner so that there is also some upwardly directed scattered light.

The functions of total internal reflection and refraction may be performed at a single step by having a multi-facet design.

FIG. 15 shows a modification based on a total internal reflection facet 150 (as in FIG. 6) nearer the input edge and a refraction facet 152 (as in FIG. 4) further from the input edge.

FIG. 16 shows a modification based on an undercut refraction facet 160 (as in FIG. 5) nearer the input edge and a total internal reflection facet 162 (as in FIG. 6) further from the input edge.

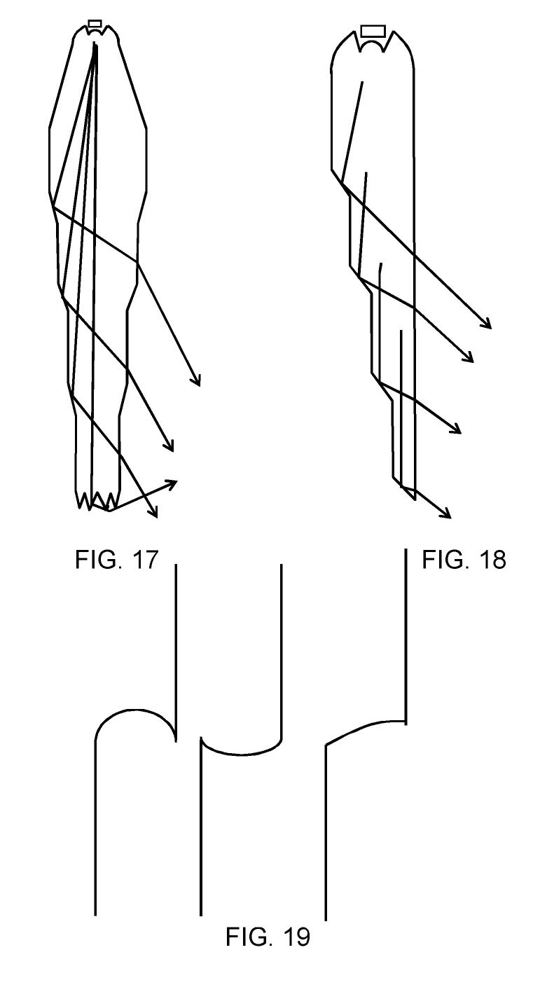

The overall system may be symmetric (about the z axis) for example as shown in FIG. 17. FIG. 17 is also used to show that the end face of the light guide may also be provided with facets in order to provide reversed light.

FIG. 18 shows that asymmetric designs are also possible. In FIG. 18 only the first side has a stepped arrangement, and the second side is planar. FIGS. 17 and 18 schematically show only total internal reflection steps to simplify the drawing, but both type of step will be used. If total internal reflection steps are provided on one side and refractive steps on the other, then all light may leave from one side only.

The steps may be formed by facets which are straight or they may be curved to broaden the outgoing beam. FIG. 19 shows three possible curved facet designs. The curvature may be the same all along the facet, so a constant cross section may be used. In such a case, the steps are straight in the length direction (y-axis).

However, the steps may instead be shaped in the length direction of the luminaire. This shaping may be based on a cylindrical design, a sinusoidal design, or any other geometric repeating shape such as diagonal lines. This may be used to prevent that the separate LEDs are visible. The LED light outputs are then smeared out to overlap, reducing the brightness of the separate LEDs into a long line of light. This improves the appearance of the device. Additionally this blurs the outgoing light somewhat, to smear out small artifacts.

The end face may be as thin as possible so that the overall width is kept to a minimum. A wider design may be used to incorporate refractive facets at the end face as shown in FIG. 17 to redirect the light that reaches this part of the light guide. This could also be beneficial for the manufacturability, since the thickness difference over the light guide may be small.

By way of example, the maximum width may be less than 20 mm or even less than 10 mm. There may be between 2 and 20 steps in the depth direction.

The entire light guide can be completely symmetric, or asymmetric.

Multiple light guide designs may be incorporated in to a product.

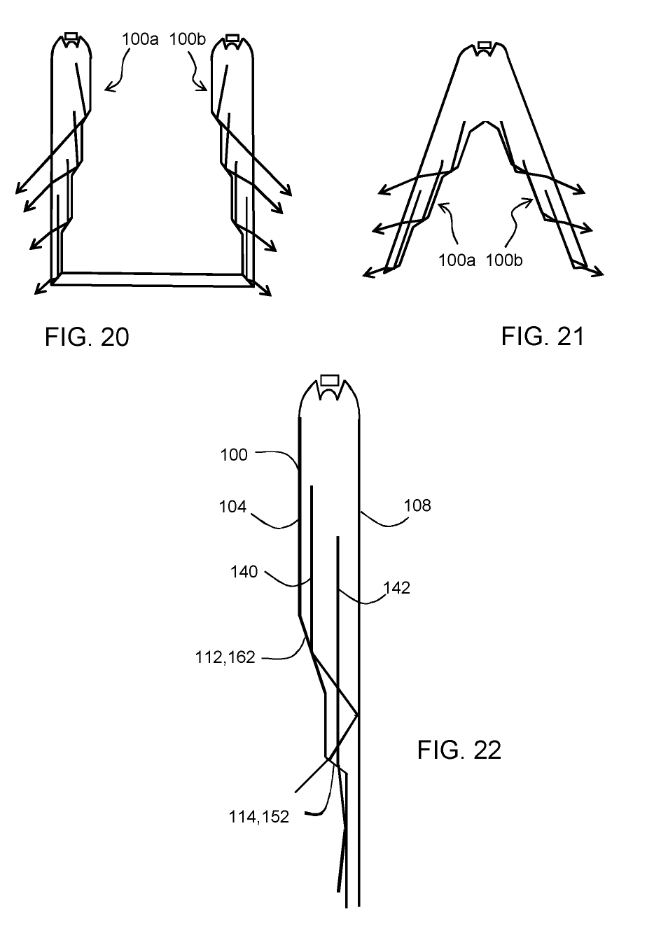

FIG. 20 shows two light guides 100a, 100b of the type shown in FIG. 18 combined to form a U-shaped lighting system, each light guide having its own light source and collimator arrangement.

FIG. 21 shows two light guides 100a, 100b of the type shown in FIG. 18 combined to form a V-shaped lighting system with a shared light source and collimator arrangement.

Again, for simplicity FIGS. 20 and 21 show total internal reflection steps only, but the light guides will each include steps of both types.

The total internal reflection steps may be on one side of the device, while the refractive steps are on the other side. Alternatively, only one side or each side may have both types of steps.

FIG. 22 shows a light guide 100 with only one side wall, i.e. first side wall 104, being provided with a refractive 152 and a TIR facet 162 and issuing light from only said one side wall 104 via both said refractive 152 and said TIR facet 162. Light ray 140 is guided inside the light guide 100 and total reflected at the TIR facet 162 in a first step region 112 of the first wall 104, subsequently totally reflected at the opposite second wall 108 and finally issued from the first wall 104 of the light guide at the refractive facet 152 at a relatively large angle with respect to the light input direction to the light guiding structure. Light ray 142 is guided inside the light guide 100 and refracted at the refraction facet 152 in a second step region 114 of the first wall 104 at a relatively small, acute angle with respect to the light input direction to the light guiding structure.

The steps can be distributed over the depth of the light guide in any desired configuration to achieve a desired aesthetic appearance and/or light distribution pattern.

The examples above show generally planar light guide designs, i.e. having a generally rectangular slab shape. The light guide may instead be curved about the z-axis and/or about the y-axis. Note that the term “planar” should thus be understood as including any general gentle curvature of the overall light guide shape, compared to the more abrupt non-planar shape of the steps.

The examples above show the light guide extending vertically down from a ceiling. However, the same design may stand vertically upright and illuminated from the base, for example for a standing lamp. In this case, the general shape of the light guide may be cylindrical. The light guide may also be used in a horizontal orientation or any other orientation, depending on the desired eventual illumination beam shape and direction that is desired.

The light guide may be formed of acrylic, polycarbonate, glass or other appropriate solid material. It may be rigid or flexible. It may be a single monolithic block but equally it may be a multi-layer structure. The light guide may be injection molded, extruded, laser etched, chemical etched or made by any other suitable process.

This invention can be used in any application where in particular control of light is preferred in small angles with respect to the main direction of the light guide. It provides extra possibilities of orienting the light guide. It is for example beneficial for outdoor light distributions with horizontal light guides or indoor applications with vertical light guides. It also enables shape freedom to use for example curved light guides with accurate control of the light distribution.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting system, comprising:
an elongate light guiding structure comprising a input edge running along the length of the structure, and a first and second opposite side walls which extend between the input edge and a end face, wherein at least one of the side walls has a stepped surface;
a light source arrangement provided at the input edge for providing light into the input edge and directed towards the end face,
wherein the steps of the stepped side wall define a narrowing of the width of the light guiding structure, and wherein the steps comprise at least a first step region which forms a total internal reflection surface for the light provided into the light guiding structure from the input edge such that light leaves the light guiding structure from the opposite side wall, and at least a second step region which forms a refracting interface for the light provided into the light guiding structure from the input edge such that light leaves the light guiding structure from the same side wall,
wherein both the first and second side walls are stepped, and
wherein both the first and second side walls each comprise a first and a second step region.

2. A system as claimed in claim 1, wherein the first and second step regions are adjacent such that they define a single narrowing region.

3. A system as claimed in claim 1, wherein the first and second step regions are spaced by a planar region, such that they define separate narrowing regions.

4. (canceled)

5. (canceled)

6. A system as claimed in claim 1, wherein a step of the first side wall and a step of the second side wall are adapted together to create an reversed light path having a direction component from the end face to the input edge.

7. A system as claimed in claim 1, wherein the steps are shaped along the elongate direction.

8. A system as claimed in claim 1, wherein the light source arrangement comprises an array of point light sources, each having a collimator.

9. A system as claimed in claim 8, wherein the elongate light guiding structure comprises a solid slab, wherein the collimators comprise a shaped part of the input edge of the slab.

10. A system as claimed in claim 8, wherein the point light sources comprise LEDs.

11. A system as claimed in claim 1, wherein the end face comprises a stepped region comprising a set of facets, for creating an reversed light path having a direction component from the end face to the input edge.

12. A system as claimed in claim 1, wherein the principal light output is from both side walls.

13. A system as claimed in claim 1, wherein the light output defines a bat wing intensity profile with one wing from each side wall.

14. A system as claimed in claim 1, further comprising a second or further elongate light guiding structure, each light guiding structure defining one web of a multiple-web design.

15. A system as claimed in claim 1, adapted to be mounted such that the direction between the input edge and the end face is vertical.
